(19) United States
(12) Patent Application Publication
(10) Pub. No.: US 2025/0044460 A1
(43) Pub. Date: Feb. 6, 2025

(54) GLOBAL NAVIGATION SATELLITE SYSTEM RECEIVER

(71) Applicant: Topcon Positioning Systems, Inc., Livermore, CA (US)

(72) Inventors: Leonid Valerianovich EDELMAN, Saint Petersburg (RU); Fedor Borisovich SERKIN, Moscow (RU); Dmitry Anatolyevich RUBTSOV, Moscow (RU); Dmitry Yuryevich GOLDBERG, Moscow (RU); Sergey Sayarovich BOGOUTDINOV, Moscow (RU)

(73) Assignee: Topcon Positioning Systems, Inc., Livermore, CA (US)

(21) Appl. No.: 18/708,628

(22) PCT Filed: Aug. 30, 2022
(86) PCT No.: PCT/RU2022/000264

§ 371 Date: May 9, 2024

(51) Int. Cl. G01S 19/36; G01S 19/37

(52) U.S. Cl. CPC G01S 19/36; G01S 19/37

(57) ABSTRACT

Navigation receiver comprising navigation system (200) includes a plurality of range frequency paths configured to receive Global Navigation Satellite Systems (GNSS) signals from an antenna and transmit the GNSS signals in a frequency range for digitizing the GNSS signals. Navigation system includes a number of Analog Digital Converters (101); a plurality of signal processors forming a plurality of signal paths (102); requantizers (103); navigation channels (104); time control (105) transmitting tick signal (S106). The navigation receiver also includes a central processing unit (CPU) system (110) which includes CPU (107). BUS (databus) (108), and memory (109), which receives data readiness flag signal (Si11). The navigation system and the CPU system connect by interface blocks (202) and (203). The invention provides increased speed of processing of navigation data.

### FIELD OF THE INVENTION

The subject matter of the present disclosure relates generally to navigation receivers and, in particular, to a receiver for processing satellite navigation signals received from satellites of different Global Navigation Satellite Systems (GNSS) such as GPS, GLONASS, etc.

### BACKGROUND

Global Navigation Satellite System receivers receive and process signals from GNSS satellites in order to determine a location of the receiver. Various techniques for processing these signals have been developed but those techniques require significant processing power which can be costly and time consuming. What is needed is a low-cost receiver using techniques that process GNSS satellite signals quickly.

### SUMMARY

A navigation receiver includes a plurality of RF paths configured to receive GNSS signals from an antenna and transmit the GNSS signals in a frequency range for digitizing the GNSS signals. The navigation receiver also includes a Navigation system and a CPU system. In one embodiment, the Navigation system is configured to process the GNSS signals based on clock CLKnav, and includes a plurality of analog to digital convertors (ADC) configured to digitize signals from the plurality of RF paths, a plurality of signal processors configured to process the digitized signals, a plurality of re-quantizers configured to convert the digitized signals into low-bit data, a plurality of interface blocks Navigation system to CPU System (NS2CS) configured to generate packages, a plurality of interface blocks CPU system to Navigation system (CS2NS) configured to convert the packages into data, a MUX interconnect configured to distribute data streams, a time control configured to generate a tick signal, and an asynchronous first-in first-out (AFIFO) configured to send low-bit data and the tick signal via a plurality of channels. In one embodiment, the CPU System is configured to process the packages based on clock CLKcpu, and includes a memory configured to store data and the packages, a plurality of hardware accelerator units configured to process the packages, a navigation Direct Memory Access (DMA) configured to convert the packages into data for a plurality of channels configured to process data from one of the navigation DMA or AFIFO, and a CPU configured to control the Navigation system and the CPU system, read the result of GNSS signal processing from the plurality of channels configured to process data from one of navigation DMA or AFIFO and process the result of GNSS signal processing.

### BRIEF DESCRIPTION OF THE DRAWINGS

FIG. 1 shows a prior art Global Navigation Satellite System (GNSS) Receiver;

FIG. 2A shows a GNSS receiver according to one embodiment;

FIG. 2B shows a GNSS receiver according to one embodiment;

FIG. 3 shows an interface block Navigation system to CPU system (NS2CS) which connects a Navigation system and a CPU system according to one embodiment;

FIG. 4A shows a signal graph of interface block NS2CS of FIG. 3 operating in single package mode according to one embodiment;

FIG. 4B shows a signal graph of interface block NS2CS of FIG. 3 operating in multi-package mode according to one embodiment;

FIG. 5 shows an interface block CPU system to Navigation system (CS2NS) which connects a CPU System and a Navigation system according to an embodiment;

FIG. 6A shows components transmitting signals to navigation DMA of FIGS. 2A, 2B, and 3 according to one embodiment;

FIG. 6B shows a data processing chain according to one embodiment;

FIG. 7 shows a timing diagram of a clocks signal for decimation according to one embodiment;

FIG. 8 shows navigation channels in communication with the navigation DMA, NS2CS and CPU system of FIG. 2A according to an embodiment;

FIG. 9A shows package processing steps according to one embodiment;

FIG. 9B shows a diagram of navigation DMA of FIGS. 2A, 2B, 3 and 4A operating in a single package mode of operation according to one embodiment;

FIG. 9C shows a diagram of navigation DMA of FIGS. 2A, 2B, 3 and 4B operating in a multi-package mode of operation according one embodiment; and

FIG. 10 shows a high-level block diagram of a computer for performing operations of the components described herein according to an embodiment.

### DETAILED DESCRIPTION

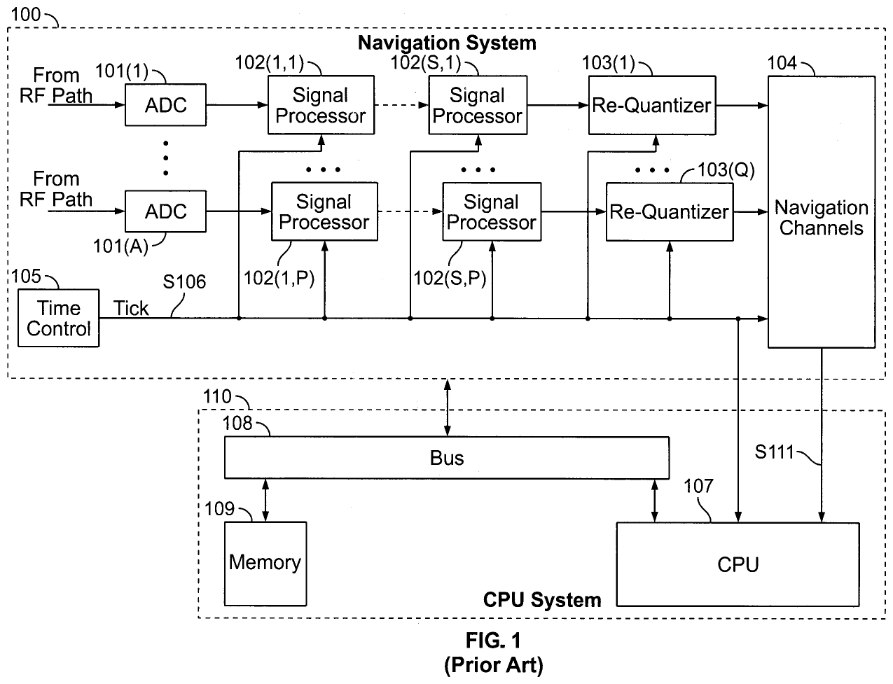

FIG. 1 shows a schematic of a prior art navigation receiver (e.g., a GNSS receiver) comprising Navigation system 100 including “A” number of Analog Digital Converters (ADC) as shown by ADC 101(1) . . . 101(A). ADCs 101(1) . . . 101(A) will be referred to collectively as ADCs 101. Navigation system 100 also comprises a plurality of signal processors forming a plurality of signal paths. A signal path comprising “S” number of signal processors is shown by signal processors 102(1,1) . . . 102(S,1). There are “P” number of signal paths as shown by signal processors 102(1,1) . . . 102(1,P). As such, the first path is shown by signal processors 102(1,1) . . . 102(S,1) and the last path is shown by signal processors 102(1,P) . . . 102(S,P). The plurality of signal processors including signal processors 102(1,1) . . . 102(1,P) and signal processors 102(S,1) . . . 102(S,P) will be referred to collectively as signal processors 102. Navigation receiver also comprises “Q” number of re-quantizers as shown by re-quantizers 103(1) . . . 103(Q). Re-quantizers 103(1) . . . 103(Q) will be referred to collectively as re-quantizers 103. The navigation receiver shown in FIG. 1 also comprises navigation channels 104, time control 105 transmitting tick signal S106, and CPU system 110 which includes CPU 107, BUS 108, and memory 109, and which receives data readiness flag signal S111.

GNSS signals received by an antenna are transmitted to one or more of the plurality of RF paths that are connected to the input of ADCs 101. The RF paths, in one embodiment, are configured to transmit the GNSS signals in a particular frequency range for digitization. In one embodiment, each of ADCs 101 receive signals from a respective one of a plurality of RF paths. In one embodiment, multiple or all ADCs 101 may receive signals from a single RF path. From the output of ADCs 101 the digitized signal is input to signal processors 102 which process the signal.

One or more components can be used as signal processors 102, for example, signal processors 102 can be a filter, noise suppressor, equalizer, and/or decimator, etc.

The signals output from signal processors 102(S, 1) . . . 102(S,P) are input to re-quantizers 103(1) . . . 103(Q) which re-quantize the received data into low-bit data. The low-bit data output from re-quantizers 103(1) . . . 103(Q) are input to navigation channels 104 which process the low-bit data.

Navigation channels 104 transmit data ready flag signal S111 to CPU 107. Data ready flag signal S111 indicates that data is ready in navigation channels 104.

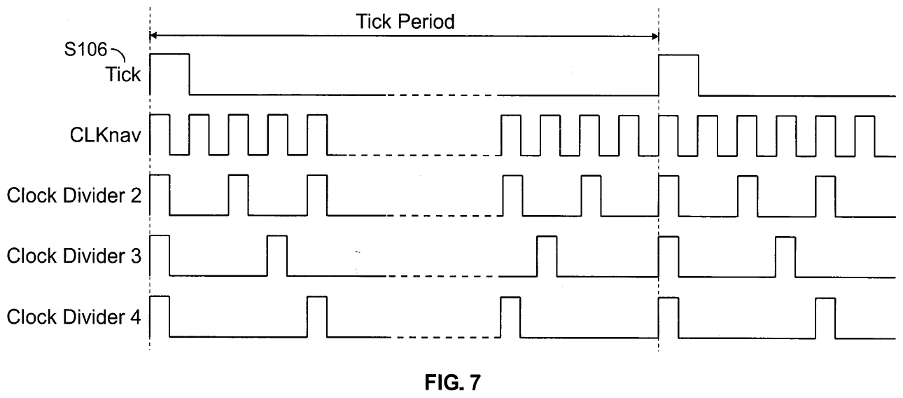

Time control 105 generates tick signal S106, which, in one embodiment, is a time scale. The period of tick signal S106 is equal to a number of clocks cycles of CLKnav, which is set by CPU 107 before operation (see FIG. 7). Tick signal S106 is input to: signal processors 102, re-quantizers 103, navigation channels 104, and CPU 107. A CPU clock, referred to as CLKcpu (not shown), is input to CPU 107, BUS 108, and memory 109. Clocks CLKnav and CLKcpu are typically asynchronous, and the CLKcpu rate is generally substantially more than the CLKnav rate.

CPU 107, memory 109, and all components of Navigation system 100 are each connected to BUS 108 which allows communication among CPU 107, memory 109, and all components of Navigation system 100. When tick signal S106 occurs, CPU 107 receives data via BUS 108 and controls Navigation system 100 based on the received data. Memory 109 is used for data storage.

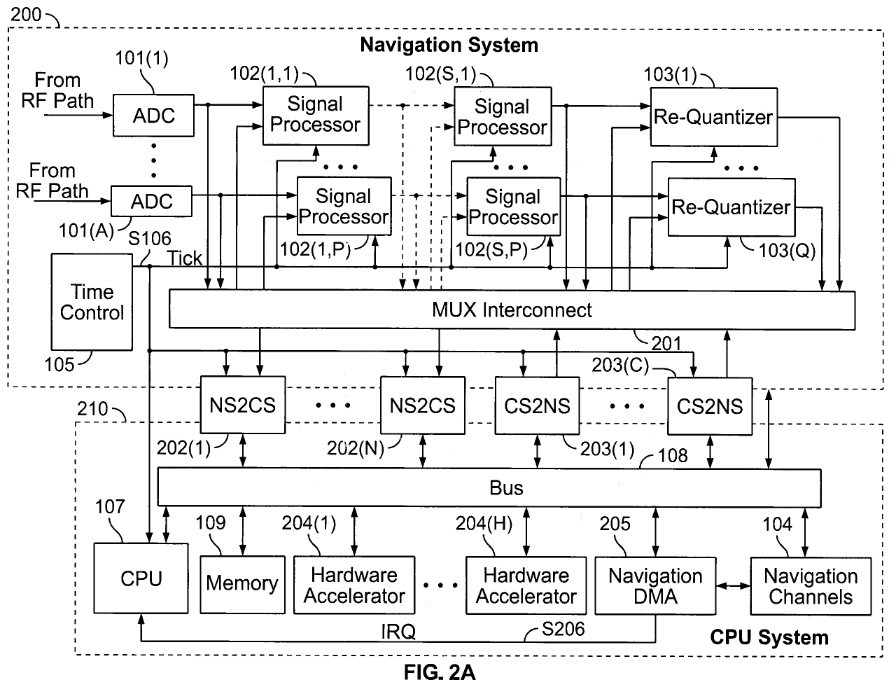

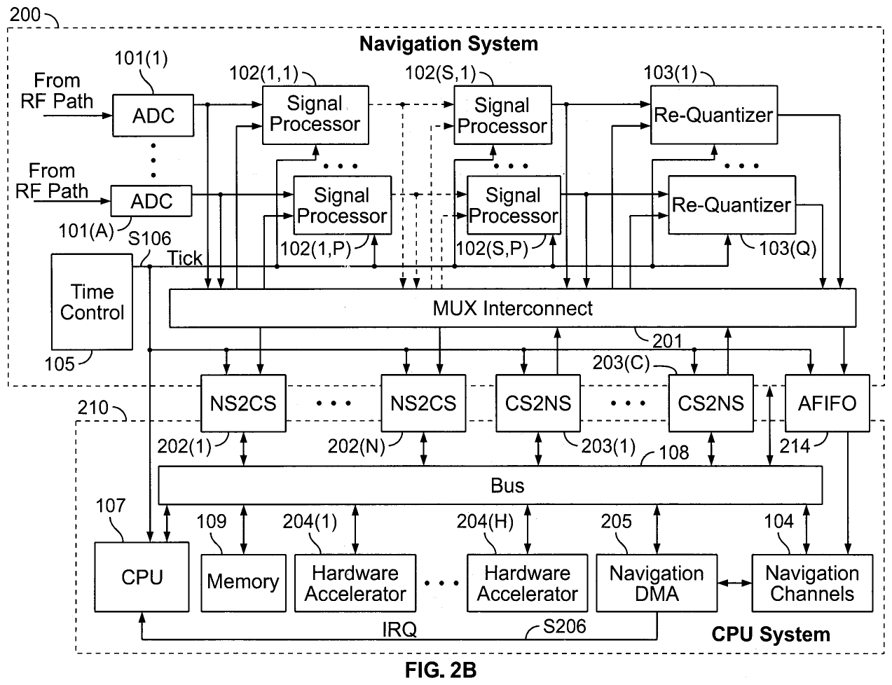

FIG. 2A shows a schematic of a GNSS receiver comprising Navigation system 200, CPU system 210. GNSS receiver also comprises MUX interconnect 201 and “N” number of interface blocks Navigation system to CPU system (NS2CS) as shown by interface blocks NS2CS 202(1) . . . 202(N) which convert data received from Navigation system 200 before being transmitted to CPU system 210. Navigation system 200 also comprises “C” number of interface block CPU system to Navigation system (CS2NS) as shown by interface blocks CS2NS 203(1) . . . 203(C) which converts data received from CPU system 210 before being transmitted to Navigation system 200, “H” number of hardware accelerators as shown by hardware accelerators 204(1) . . . 204(H), and navigation Direct Memory Access (DMA) 205. Interface blocks NS2CS 202(1) . . . 202(N) will be collectively referred to as interface blocks NS2CS. Interface blocks CS2NS 203(1) . . . 203(C) will be referred to collectively as interface blocks CS2NS 203. Hardware accelerators 204(1) . . . 204(H) will be referred to collectively as hardware accelerators 204. FIG. 2A shows interrupt request signal (IRQ) S206 which is output from navigation DMA 205 and input to CPU 107.

GNSS signals received by an antenna are transmitted to one or more RF-paths that are connected to the input of ADCs 101. Digitized signals output from ADCs 101 are input to signal processors 102 where the signals are processed. The outputs of signal processors 102 are input to re-quantizers 103 where the signals are re-quantized into low-bit data.

The output of re-quantizers 103, ADCs 101 and signal processors 102, are input to MUX interconnect 201. MUX interconnect 201 transmits the output of re-quantizers 103, ADCs 101 and signal processors 102 to the input of interface blocks NS2CS 202(1) . . . 202(N) where the signals can be further processed.

Signals output from interface blocks CS2NSs 203 are input to MUX interconnect 201. The signals output from interface blocks CS2NS 203 using MUX interconnect 201 are input to any one of Navigation system 200, re-quantizers 103 and signal processors 102, where the signals are processed.

Time control 105 generates tick signal S106 which is used to control various components and is input to: signal processors 102, re-quantizers 103, CPU 107, interface blocks NS2CS 202, and/or interface blocks CS2NS 203.

CPU 107 uses tick signal S106 to synchronize control among signal processors 102, re-quantizers 103, interface blocks NS2CS 202, interface blocks CS2NS 203, and/or hardware accelerators 204, 205.

The CLKnav and CLKcpu clocks are generally asynchronous, and the CLKcpu frequency is substantially higher than the CLKnav frequency. In one embodiment, the frequency of the CPU 107 is synchronous and substantially higher than CLKcpu. In one embodiment, Navigation System 200 operates based on clock CLKnav and comprises: ADC 101, signal processors 102, re-quantizers 103, time control 105, MUX interconnect 201, interface blocks NS2CSs 202, interface blocks CS2NS 203. In one embodiment, CPU System 210 operates based on clock CLKcpu and comprises: navigation DMA 205, navigation channels 104, CPU 107, BUS 108, memory 109, interface blocks NS2CS 202, interface blocks CS2NS 203, hardware accelerators 204.

In one embodiment, the frequency of CPU 107 is synchronous and much higher than CLKcpu. In another embodiment, the frequency of operation of navigation channels 104 and navigation DMA 205 is synchronous and significantly higher than CLKcpu.

In one embodiment, the following components are connected to BUS 108: navigation DMA 205, CPU 107, memory 109, Navigation system 200, interface blocks NS2CS 202, interface blocks CS2NS 203, hardware accelerators 204, and navigation channels 104.

CPU 107 controls the following components via BUS 108: navigation DMA 205, Navigation system 200, interface blocks NS2CS 202, interface blocks CS2NS 203, hardware accelerators 204, and navigation channels 104.

In one embodiment, CPU 107 is configured to write data to memory 109 and hardware accelerators 204 via BUS 108. In one embodiment, memory 109 is used to store data.

The following components can be a source of data: ADC 101, signal processors 102, re-quantizers 103, hardware accelerators 204, interface blocks NS2CS 202, interface blocks CS2NS 203, and CPU 107.

After processing, each of re-quantizers 103 form the same number of samples in a period of time. The outputs of each re-quantizer 103 are collected into one stream and transmitted via MUX interconnect 201 to the input of one interface block NS2CS 202 for further processing. In one embodiment, one interface block NS2CS 202 is allocated for further processing.

In one embodiment, the output of re-quantizer 103 is input to interface block NS2CS 202. Interface block NS2CS 202, in one embodiment, writes data from Navigation system 200 via BUS 108 into: memory 109, hardware accelerator 204, and/or CPU 107.

In one embodiment, interface block CS2NS 203 transmits data from memory 109 to Navigation system 200 via BUS 108. When the transmit operation is over, interface block CS2NS 202 interrupts operation of CPU 107.

One of hardware accelerator 204 writes the result of data processing via BUS 108 into: memory 109, a different one of hardware accelerator 204, and/or CPU 107.

Hardware accelerators 204 can be a Coarse-Grained Reconfigurable Architecture (CGRA) which may be built into an Application Specific Integrated Circuit (ASIC)), Field Programmable Gate Array (FPGA), which may be embedded in an ASIC, a spectrum analyzer or other devices. When data is processed, hardware accelerators 204 generates an interrupt request (IRQ) that is transmitted to CPU 107 and signal S707 is transmitted to navigation DMA 205.

Navigation DMA 205 reads data from memory 109 via BUS 108. Navigation DMA 205 transmits data from memory 109 to navigation channels 104, where they are processed. After completion of operation navigation DMA 205 outputs IRQ signal S206 to CPU 107.

CPU 107, using tick signal S106 and IRQs (e.g., IRQ S206) from navigation DMA 205, interface blocks NS2CS 202, interface blocks CS2NS 203, and hardware accelerators 204, controls data streams between: navigation DMA 205, interface blocks NS2CS 202, interface blocks CS2NS 203, hardware accelerators 204.

FIG. 2B shows a GNSS receiver similar to the GNSS receiver shown in FIG. 2A. However, FIG. 2B includes the additional component, Asynchronous First-In First-Out buffer (AFIFO) 214. In one embodiment, the outputs of re-quantizers 103 and tick signal 106 are connected to the input of AFIFO 214 via MUX interconnect 201. Each clock pulse of CLKnav samples from re-quantizers 103 and tick signal S106 are input to AFIFO 214.

After samples are re-synchronized to clock CLKcpu, they are output from re-quantizer 103 to navigation channels 104, where the samples are processed. After re-synchronization to clock CLKcpu, tick signal S106 is input to navigation channels 104, where it is used to process samples from re-quantizers 103.

Data from AFIFO 214 to navigation channels 104 (i.e., to internal logic of navigation channels 104) are transmitted based on clock CLKcpu. AFIFO 214 implements re-synchronization of data from clock CLKnav to clock CLKcpu.

When navigation channels 104 works with data (samples from re-quantizers 103 and tick signal S106) from AFIFO 214, the navigation receiver operates in an operation mode equivalent to that of a standard GNSS receiver, and navigation DMA 205 is not used.

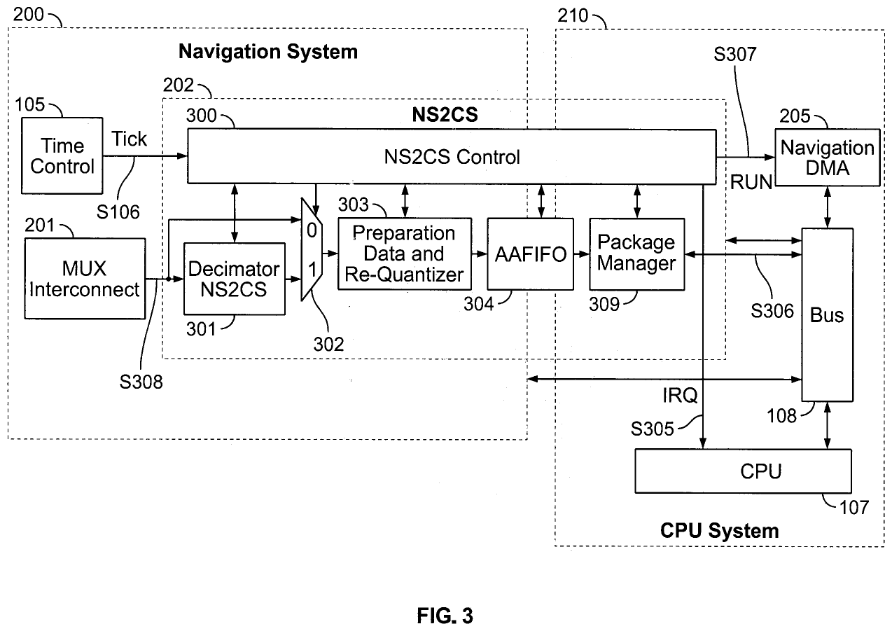

FIG. 3 shows a schematic of interface block NS2CS 202 of FIG. 2 and signal transmissions from Navigation system 200 to CPU system 210. Interface block NS2CS 202 comprises: NS2C control 300, decimator NS2CS 301, multiplexer 302, preparation data and re-quantizer 303, asymmetric Asynchronous First-In First-Out (AAFIFO) 304, and package manager 309. FIG. 3 shows multiple signals, including IRQ signal S305 from NS2CS control 300 of interface block NS2CS 202, output S306 of interface block NS2CS 202, RUN signal S307, and continuous data stream S308 from MUX interconnect 201.

In one embodiment, before starting CPU 107, NS2CS control 300 configures: decimator NS2CS 301 (if necessary), multiplexer 302, preparation data and re-quantizer 303, AAFIFO 304, and package manager 309. In one embodiment, preparation data and re-quantizer 303 converts samples from a multilevel digitized signal into a 2-level signal. In one word, BUS 108 fits many 2-level samples. NS2CS 202 performs data pre-processing and converts the data from the MUX Interconnect 201 into the required format for navigation DMA 205, CPU 107, memory 109, or hardware accelerators 204. In one embodiment, the data stream output from NS2CS 202 is a package.

In one embodiment, a package is the number of samples assigned or set by CPU 107. Samples are data over one clock period. Service information or additional information can be added to the package from NS2CS control 300 if needed to control hardware accelerator 204. In one embodiment, interface block NS2CS 202 generates a package according to tick signal S106. In one embodiment, interface block NS2CS 202, generates a package which is then stored in memory 109.

In various embodiments, package data can be processed in: signal processors 102 using interface block CS2NS 203, re-quantizer 103 using interface block CS2NS 203, navigation channels 104 using navigation DMA 205, CPU 107, and or hardware accelerators 204.

In various embodiments, a package can be generated in: CPU 107, interface block NS2CS 202, and/or hardware accelerator 204. A continuous data stream S308 from MUX interconnect 201 is input to decimator NS2CS 301 and, if needed, the signal is decimated with different decimation coefficients and is input to preparation data and re-quantizer 303. Preparation data and re-quantizer 303 prepares data and, if needed, re-quantizes data in low-bit data. If decimation is not used, then continuous data stream S308 from MUX interconnect 201 enters the input of the multiplexer 302 and further goes to the preparation data and re-quantizer 303. Output data from preparation data and re-quantizer 303 passes AAFIFO 304 and are input to package manager 309, where they are converted into a package with the given sample number. AAFIFO 304 re-synchronizes data from clock CLKnav to clock CLKcpu.

In one embodiment, during operation, interface block NS2CS 202 stacks data at given addresses and generates an IRQ signal S305 for CPU 107. If necessary, data is written cyclically. In another embodiment, decimator NS2CS 301 is removed to reduce interface block NS2CS 202 spaces in ASIC.

Interface block NS2CS 202 operates in two modes: single package mode and multi packages mode.

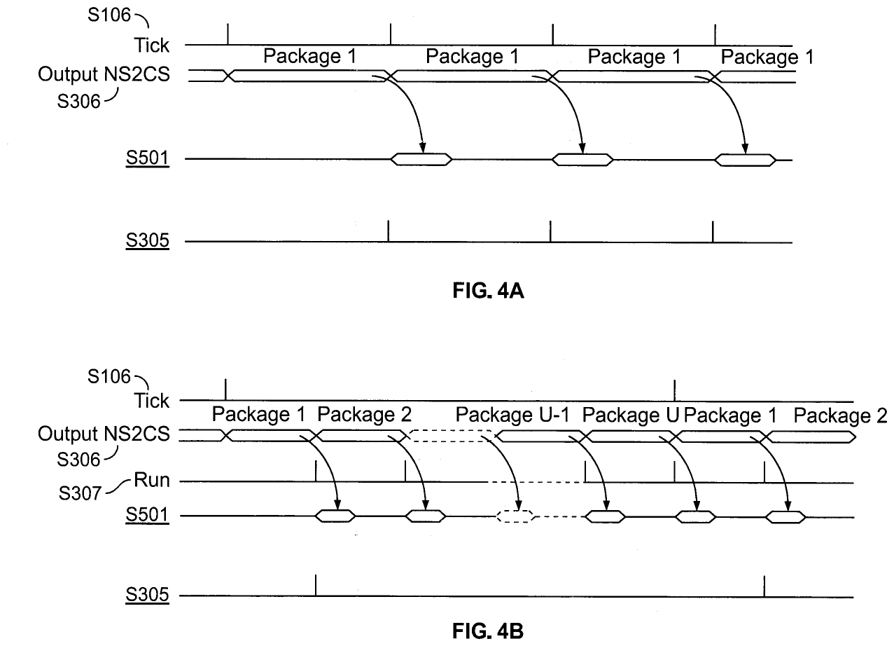

FIG. 4A shows a signal graph of interface block NS2CS 202 operating in single package mode. During one tick period signal S106 one package is formed. When the package is formed, IRQ signal S305 is generated and input to CPU 107. In this mode, CPU 107 has control of data stream using tick signal S106 and IRQ signals from interface block NS2CS 202, interface block CS2NS 203, and hardware accelerators 204, 205. In one embodiment, navigation DMA 205 forms multi-bit data signal S501 for navigation channels 104.

FIG. 4B shows a signal graph of interface block NS2CS 202 operating in multi packages mode. Time control 105 generates tick signal S106, according to which data processing starts. During one period of tick signal S106, U packages are formed. When the first package had been formed and has been written to memory 109, signal S305 is generated. After completion of each package, RUN signal S307 is generated. In one embodiment, packages 1 . . . U have the same size. In another embodiment, packages 1 . . . U have different sizes. Navigation DMA 205 reads a package from memory 109 and forms multi-bit data signal S501 for navigation channels 104, based on signal S307. When necessary, an additional operation with respect to a package is performed, specifically, any time after writing a packet to memory 109, interface block NS2CS generates the S305 and S307 signals.

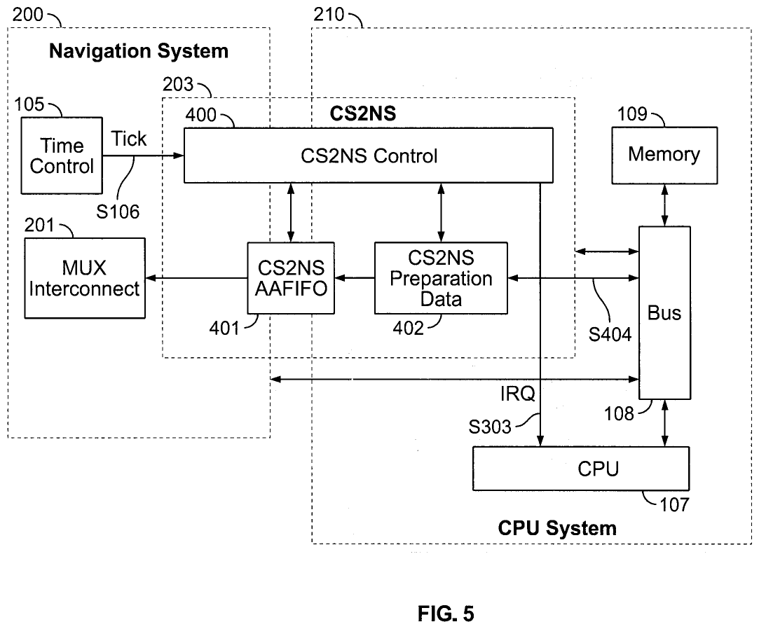

FIG. 5 shows a schematic of interface block CS2NS 203 and signal transmissions from Navigation system 200 to CPU system 210. Interface block CS2NS 203 comprises: CS2NS control 400, CS2NS preparation data 402, and CS2NS asynchronous asymmetric FIFO (CS2NS AAFIFO) 401. FIG. 5 also shows IRQ signal S303 output from CS2NS control 400.

In one embodiment, before operation, CPU 107 adjusts: CS2NS preparation data 402 and CS2NS AAFIFO 401. After operation begins, interface block NS2CS 203 reads part of the package from memory 109 before tick signal S106 is received. Interface block NS2CS 203 begins issuing samples after tick signal S106 is received. An entire package is transmitted to MUX interconnect 201 based on clock CLKnav (not shown but is used to synchronize package transmission).

After operation of interface block NS2CS 203 begins, data from BUS 108 is input to CS2NS preparation data 402 where the data is processed. Data output from CS2NS preparation data 402 is input to CS2NS AAFIFO 401. Before tick signal S106 occurs, data from CS2NS AAFIFO 401 is input to MUX Interconnect 201 until the package delivery is finished.

In one embodiment, after an entire package has been read from memory 109, the next package is read, if necessary, to ensure a continuous stream of data processed on CLKnav. At the end of outputting a package to CS2NS AAFIFO 401, CS2NS 203 generates IRQ signal S303. CS2NS AAFIFO 401 re-synchronizes data from clock CLKcpu to clock CLKnav.

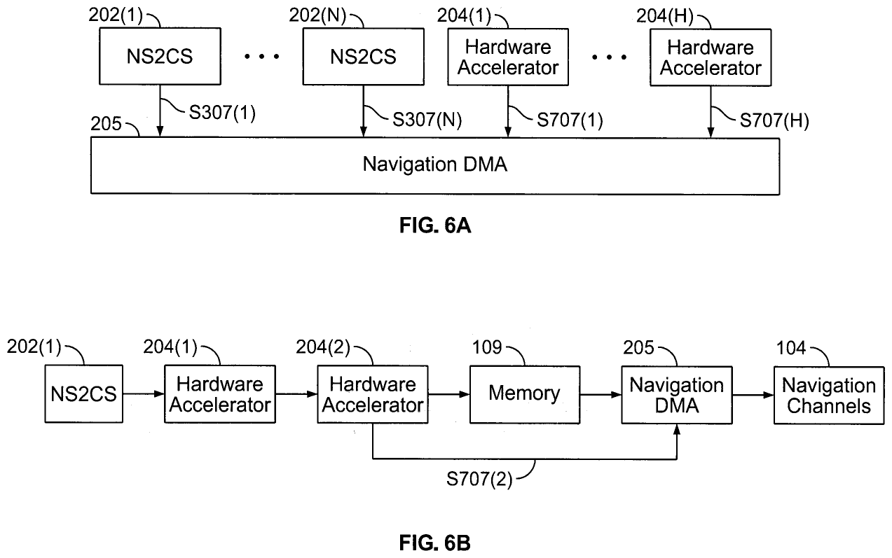

FIG. 6A shows signals received by navigation DMA 205. Signals received by navigation DMA 205 include “H” number of RUN signals as shown by RUN signals S707(1) . . . . S707(H) from the output of “H” number of hardware accelerators as shown by hardware accelerators 204(1) . . . 204(H), respectively. Signals received by navigation DMA 205 also include “N” number of signals from the output of interface block NS2CS as shown by signals S307(1) . . . . S307(N). The signals received by navigation DMA 205 as described are used in a first-try automatic mode.

In one embodiment, from hardware accelerators 204 signals S707 are received by navigation DMA 205. Signals S707 are transmitted at the end of writing a package into memory 109. Signals S707 are used by navigation DMA 205 in a manner similar to signals S307, and are also used in the First-try automatic mode.

In one embodiment, Navigation DMA 205, using signals S307 and S707, reads packages from memory 109 and generates signals S501 (see FIGS. 4A and 4B) from different data sources interface blocks NS2CS 202 and/or hardware accelerators 204.

Interface block NS2CS 202, interface block CS2NS 203, and hardware accelerators 204, 205 can be arranged in a data processing chain. During operation of the data processing chain, the data is transmitted from one module to another without participation of CPU 107.

In one embodiment as shown in FIG. 6B, data is processed in a chain starting with a package from the output of the interface block NS2CS 202(1) input to hardware accelerator 204(1) where the package is processed. The result of processing of the package by hardware accelerator 204(1) is input to hardware accelerator 204(2). The result of processing of the package from hardware accelerator 204(2) is written to the memory 109. After processing of the package, hardware accelerator 204(2) generates signal S707(2). Based on signal S707(2) navigation DMA 205 sends data (signal S501) to navigation channels 104.

In navigation system 200 (as shown in FIGS. 2, 3, and 5), the signal is decimated by signal processor 102 (which, in this case, is a decimator).

FIG. 7 shows one of several possible variants for a clock generating a clock signal referred to as a Clock for Decimation. Tick signal S106 has a particular tick period. Tick signal S106 consists of multiple ClkNav. Clock divider 2 signal shows ClkNav divided by 2. Similarly, Clock Divider 3 signal shows ClkNav clock divided by 3 and Clock Divider 4 signal shows ClkNav clock divided by 4. In one embodiment, a signal is input to signal processor 102 (which is a Decimator in this variant) to control decimation. In one embodiment, tick signal S106 is used for all components (for all clocks divide) at the same time (for all decimation coefficients).

When using decimation, the number of samples at the input of interface block NS2CS 202 is reduced, which reduces the size of packages. In one embodiment, the interface blocks NS2CS convert the received digitized signal into a package having a pre-set or designated size.

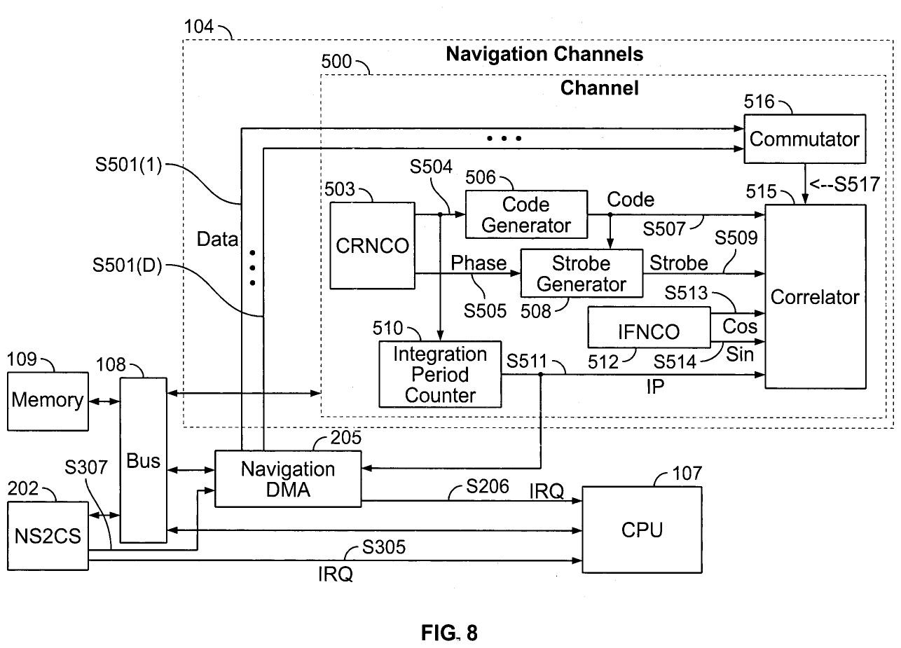

FIG. 8 shows navigation channels 104 in communication with the CS2NS CPU system of FIG. 5 according to an embodiment. As shown in FIG. 8, navigation channels 104, in one embodiment, includes: channel 500, “D” number of signals as shown by signals S501(1) . . . . S501(D) from navigation DMA 205, code rate NCO (CRNCO) 503, code rate signal S504, code phase signal S505, code generator 506, code signal S507, strobe generator 508, strobe signal S509, integration period counter 510, integration period (IP) signal S511, Intermediate Frequency NCO (IFNCO) 512, cosine signal S513, sin signal S514, correlator 515, commutator 516, and output signal from commutator S517.

In one embodiment, navigation channels 104 consists of multiple channels 500. FIG. 8 shows channel 500 which is one of the multiple channels. In one embodiment, a package can contain data from one or more data sources. Data from different sources can be combined in one package over a time period with the same number of samples. Low-bit data received from the outputs of different re-quantizers 103 (shown in FIGS. 2A, 2B, and 3) is multiplexed in a single multi-digit word and input to an allocated interface block NS2CS 202 to generate a common package which is transmitted to memory 109 where it is saved. Navigation DMA 205 reads the package from memory 109 and converts (data from re-quantizers 103(1) . . . 103(Q)) into “D” number of signals as shown by signals S501(1) . . . . S501(D). Data from each of re-quantizers 103(1) . . . 103(Q) is transmitted as signals S501(1) . . . . S501(D), respectively.

Navigation DMA 205 sends one package to navigation channels 104 during generation of the next package. CPU 107 via BUS 108 controls navigation DMA 205. Before operation, CPU 107 adjusts navigation DMA 205 to operate in one of several modes.

Navigation DMA 205 can operate in the following modes: CPU fully controlled mode and first-try automatic mode.

In the CPU fully controlled mode according to one embodiment, CPU 107 controls navigation DMA 205 and channels 500. In one embodiment, the CPU fully controlled mode is only used when interface block NS2CS 202 operates in single package mode. Time control 105 generates tick signal S106, which run data process. Interface block NS2CS 202 operates in single package mode. When a package is formed, signal S305 is generated. According to signal S305, CPU 107 writes a control command in navigation channels 104 and then, according to a command from CPU 107, navigation DMA 205 sends the package. When the package is sent, navigation DMA 205 generates signal S206. CPU 107 reads data from Navigation Channels 104 based on signal S206 An advantage of this mode is a more flexible chain of data processing, since CPU 107 can itself determine to which block it will send data.

In the first-try automatic mode according to one embodiment, CPU 107 controls. 205 and channels 500, where navigation DMA 205 itself using signals S307 and S707 sends packages via channels 500. In one embodiment, the first-try automatic mode is used only when interface block NS2CS 202 operates in multi packages mode. Time control 105 generates tick signal S106, which run data process. After the first package is completely sent, signal S305 is generated. CPU 107, according to signal S305, sends a control command to navigation channels 104, and further, on CPU command, navigation DMA 205 sends the package. At the end of each package, according to RUN signal S307, navigation DMA 205 is run and the package is sent to navigation channels 104. After the last package, based on current tick signal S106, navigation DMA 205 generates signal S206. CPU 107 according to signal S206 reads data from navigation channels 104. An advantage of this mode is that the smaller packages require less memory. In addition, power consumption is less because this mode required less control form the CPU.

When a package is ready, navigation DMA 205 reads it from memory 109 and generates multi-bit data signal S501. When data signal S501(1) is sent via commutator 516, every clock, signal S501 is sent to processing logic in channels 500. When data S501(D) is sent via commutator 516, every clock, signal S501 is sent to processing logic in channels 500.

Navigation DMA 205 in the CPU fully controlled mode generates IRQ signal S206 at the end of the package, after data is sent to channels 500, that corresponds to the period of tick signal S106.

Navigation DMA 205 in the First-try automatic mode generates IRQ signal S206 one time for some packages, when data transmission to channels 500 is over, and IRQ signal S206 corresponds to the period of tick signal S106.

Signals S501(1) . . . . S501(D) are transmitted from navigation DMA 205 to the input of commutator 516. CPU 107, in conjunction with commutator 516, connects channel 500 to signal S501(i), where i is any number from 1 to D.

While navigation DMA 205 is reading a package from memory 109, if there is not enough data to form signal S501 (i.e., navigation DMA 205 did not have time to read data from memory) channels 500 stops data processing for this period of time.

Navigation Channels 104 consists of a set of channels 500. CPU 107 controls and retrieves data from channels 500 via BUS 108. In channels 500, each sample from a package is processed in one clock cycle of CLKcpu.

In one embodiment, the period of tick signal S106 is smaller than the period of integration period signal S511.

The current channel 500 configuration is a group of settings defined for the selected processing mode of the GNSS signal. For example, the parameters are the selected S501(i) and the configuration of code generator 506.

In one embodiment, CPU 107 configures, controls, and retrieves data from channel 500 when navigation DMA 205 does not send data signal S501. Before operation, CPU 107 sets the current configuration of components and parameters of channel 500 as follows: code frequency and initial code phase in code rate NCO 503, code generator 506, strobe generator 508, duration of integration period signal S511 in integration period counter 510, intermediate frequency and initial code phase in intermediate frequency NCO 512, and commutator 516.

In one embodiment, channel 500 processes input signals S501(i) from the beginning to the end of a package.

CRNCO 503 generates code frequency signal S504 which is input to code generator 506 and integration period counter 510. Code generator 506 generates code signal S507 at the rate of signal S504. Code signal S507 is input to strobe generator 508 and correlator 515. CRNCO 503 generates code phase signal S505 which is input to strobe generator 508. Strobe generator 508 using signals S507 and S505 generates strobe signal S509 which is input to Correlator 515. IFNCO 512 generates signals Cosine (Cos) S513 and Sin S514 having intermediate frequency. Signals S513 and S514 are input to correlator 515. From commutator 516, signal S517 is input to correlator 515. Integration period counter 510 generates integration period signal S511 based on code rate signal S504. Integration period signal S511 is input to correlator 515 and navigation DMA 205. In one embodiment, signal S517 is signal S501(i). Navigation DMA 205 fixes signals S511 during tick period S106.

In correlator 515, signal S517 is multiplied by Cos signal S513 and code signal S507 and the result of the multiplication is accumulated over integration period signal S511. According to integration period signal S511, the accumulated value is saved in buffer register 1 (component I shown below), and CPU 107, if needed, takes this value, and the accumulated value is zeroed.

$$I = {\sum }_{1}^{IP} S 517 * S 513 * S 507$$

In correlator 515, signal S517 is multiplied by Sin signal S514 and code signal S507 and the result of the multiplication is accumulated over integration period signal S511. According to signal S511, the accumulated value is saved in buffer register 2 (component Q shown below), and CPU 107, if needed, takes this value, and the accumulated value is zeroed.

$$Q = {\sum }_{1}^{IP} S 517 * S 514 * S 507$$

In correlator 515, signal S517 is multiplied by signal Cos S513 and strobe signal S509 and the result of the multiplication is accumulated over integration period signal S511. According to signal S511 the accumulated value is saved in buffer register 3 (component dI shown below), and CPU 107, if needed, takes this value, and the accumulated value is zeroed.

$$dI = {\sum }_{1}^{IP} S 517 * S 513 * S 509$$

In correlator 515, signal S517 is multiplied by Sin signal S514 and strobe signal S509 and the result of the multiplication is accumulated over integration period signal S511. According to signal S511 the accumulated value is saved in buffer register 4 (component dQ shown below), and CPU 107, if needed, takes this value, and the accumulated value is zeroed.

$$dQ = {\sum }_{1}^{IP} S 517 * S 5 \; 14 * S 509$$

Based on signal S206, CPU 107, if signal S511 is fixed in navigation DMA 205 and is available, reads ready data from channel 500 including values from buffer registers 1 through 4 (components I, Q, dI, dQ). Note that it is also possible to read code phase CRNCO 503, intermediate frequency phase in IFNCO 512 and the state of integration period counter 510 and so on.

Before processing according to signal S501(i) CPU 107 can control/modify parameters of channel 500, including changing code frequency in CRNCO 503, setting code phase shift in CRNCO 503, changing intermediate frequency in IFNCO 512, setting intermediate frequency phase shift in IFNCO 512 and so on.

Operation of strobe generator 508 is described in U.S. Pat. No. 7,764,226 B1, the disclosure of which is incorporated herein by reference in its entirety.

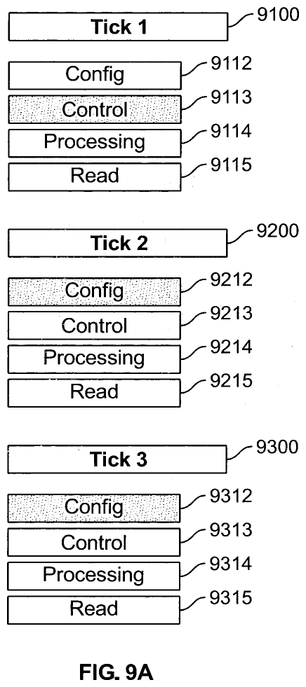

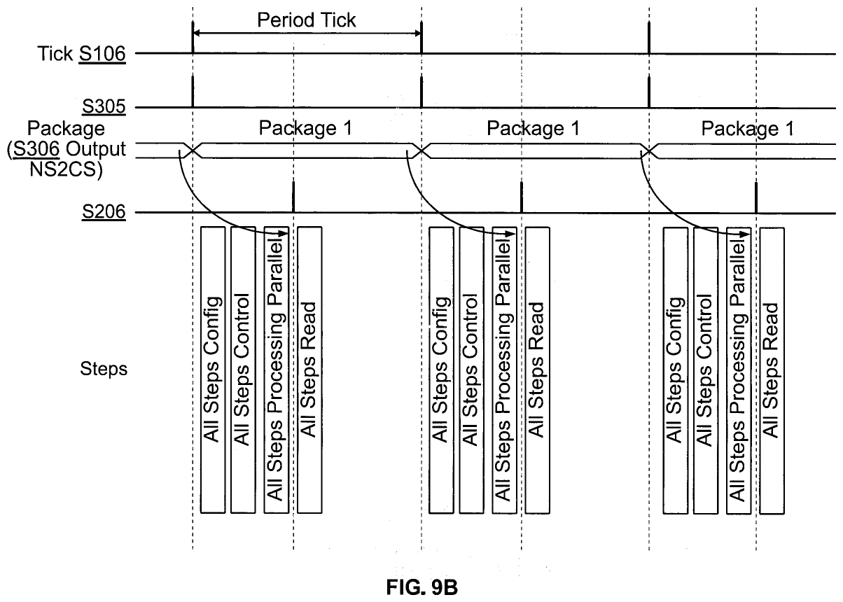

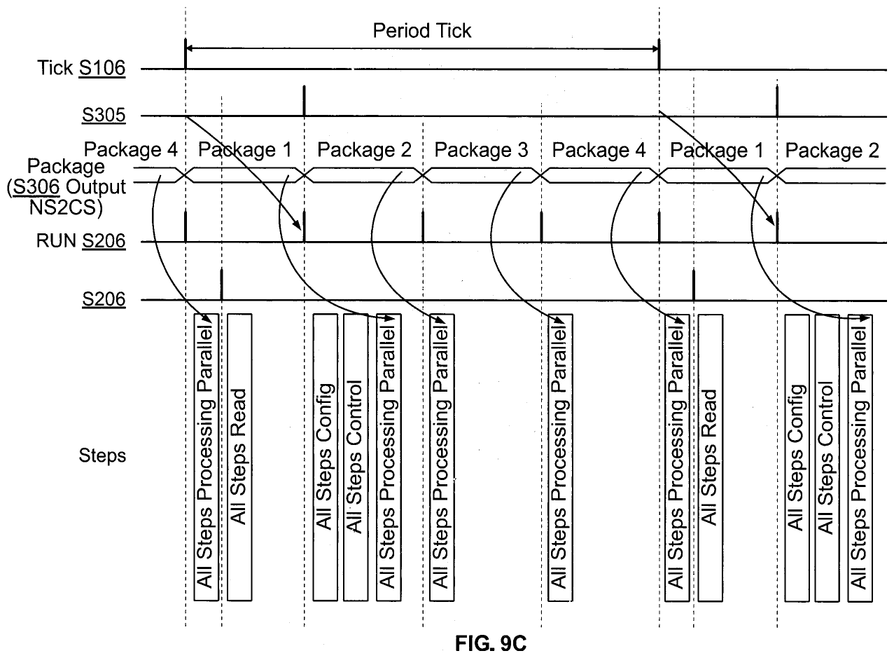

FIG. 9A shows package processing steps which are described as follows.

Signals S305, S307 and S707 indicate to navigation DMA 205 that there is a new package in memory 109. CPU 107, using a combination of signals S106, S206, S307, S707 controls GNSS signals processed in channels 500. Package processing with navigation DMA 205 includes the following steps. Below table is describe package processing steps. The designation column of the table indicates that the last digit of the labels of FIG. 9A are associated with a particular step (i.e., labels 9112, 9212, and 9312 are each associated with the configuration step, labels 9113, 9213, and 9313 are each associated with the control step, etc.)

| Step | Designation | Description |
|---|---|---|
| Config | ***2 | Channel 500 is prepared to process a GNSS signal, a |
| (Configuration) | | new current configuration of Channel 500 is set |
| | | Or previously run GNSS signal processing is stopped. |
| Control | ***3 | A control command is sent to Channel 500. |
| Processing | ***4 | Channel 500 processes S501(i) |
| Read | ***5 | Ready data is taken from Channel 500, further processed. |

In one embodiment, during the formation of a new package, all the steps required for each current channel configuration must be completed.

In CPU fully controlled mode configuration and control steps are controlled by CPU 107. During the configuration and control steps, the CPU 107 controls channel 500 before sending a package to channel 500. The read step is controlled by CPU 107. At the read step, the CPU 107 reads the ready data from the channel 500, after processing a package in channel 500. Navigation DMA 205 generates IRQ signal S206 after processing a package (after the processing step).

In first-try automatic mode, configuration and control steps are controlled by CPU 107. CPU 107, during configuration and control steps, controls channel 500, before the first package formed during period of tick signal S106 is sent to channel 500. The read step is controlled by CPU 107. In the read step, the CPU 107 reads the ready data from the channel 500 after channel 500 has processed the last package generated during period of tick signal S106. Navigation DMA 205 generates IRQ signal S206, after processing, in channel 500, the last package (after the processing step) generated during period of tick signal S106.

In one embodiment, the following steps are performed in the sequence as shown:

### Configuration Step:

For a plurality of channels 500, configuration steps can be used one after another. If it is needed to run a new GNSS signal processing, channels 500 is set to a new configuration. Channels 500 can also stop GNSS signal processing if needed.

### Control Step:

For a plurality of channels 500, control steps are used one after another. If needed, control commands are sent to channel 500.

### Processing Step:

Processing steps are applied for all channels 500 at the same time (in parallel). Packages (represented by signal S501) are sent to all channels 500 simultaneously. Each Channel 500 processes its own package received as signal S501(i).

### Read Step:

If needed, for a plurality of channels 500, read steps are used sequentially. If signal S511 is available in navigation DMA 205, ready data is retrieved from channels 500.

In one embodiment, CPU 107 can, if necessary, read data from channels 500 without using navigation DMA 205, temporarily stopping the operation of 205 after signal S206.

In one embodiment, channels 500 do not process previously configured current configurations and CPU 107 will not set one or more new current configurations of channels 500, then navigation DMA 205 does not send a package (i.e., navigation DMA 205 skips all steps) to channels 500 and generates signal S206.

The use of CPU 107 for steps Config and Control in the modes CPU fully controlled and first-try automatic guarantees the synchronicity of control for all channels 500.

In FIG. 9A, steps having shaded backgrounds are not active (i.e., not used). In one embodiment, the time of package generating is equal to the period of tick signal S106 (see FIG. 7).

In one embodiment, channel 500(1), in its current configuration, Config 1, processes signal S501(i). In the Config 1 configuration, data packages are processed in the same way as they are in operation of channel 500 in the typical GNSS receiver (shown in FIG. 1.) in a pipeline mode.

The Config 1 configuration, in one embodiment, is carried out in the following way: At Tick 1 9100—the current configuration is set, the GNSS signal is processed, and, if needed, data is read; and at Tick 2 9200 and at Tick 3 9300—control step is used, GNSS signal processing continues, and, if needed, data is read.

In one embodiment shown in FIG. 9A, the steps are carried out in the following sequence:

Once tick signal S106 number 1 (i.e., Tick 1 9100) has occurred, the following steps are performed: Config 9112 sets Config 1; Processing 9114; and Read 9115.

Once tick signal S106 number 2 (i.e., Tick 2 9200) has occurred, the following steps are performed: Control 9213 for Config 1; Processing 9214; and Read 9215.

Once tick signal S106 number 3 (i.e., Tick 3 9300) has occurred, the following steps are performed: Control 9313 for Config 1; Processing 9314; and CPU Read 9315.

It should be noted that, in one embodiment, in single GNSS signal processing mode—Channels 500 always operates in the current configuration which corresponds to Config 1.

FIG. 9B shows a diagram of navigation DMA 205 operation in CPU fully controlled mode.

A package corresponds to period tick S106. In CPU fully controlled mode, CPU 107 uses Tick signals S106, S305 and S206 and fully controls GNSS signal processing using navigation DMA 205 to control the steps Config, Control, and Read. Interface block NS2CS 202 starts to form package based on tick signal S106. CPU 107 receives signal S305 and executes Config and Control Steps. In Processing Step, navigation DMA 205 transmits package to navigation channels 104 by command CPU 107. Navigation DMA 205 finishes transmitting package and generates signal S206. CPU 107 receives signal S206 and executes Read Step. Then all the steps are repeated cyclically.

FIG. 9C shows a diagram of navigation DMA 205 operation in the First-try automatic (wherein 4 packages are formed per period of Tick) mode.

Over period tick signal S106, four packages are formed (e.g., in multi packages mode). In First-try automatic mode, the processing of package 2 and package 3 does not require any control from CPU 107. After processing package 4, CPU 107 receives signal S206 and reads ready data from channels 500. NS2CS 202 starts to form a package by tick signal S106. CPU 107 receives signal S305 and executes Config and Control steps. In Processing step, navigation DMA 205 transmits package 1 to Navigation channels 104 by command CPU 107. In Processing steps, navigation DMA 205 transmits package 2, package 3 and package 4 to navigation channels 104 by signal S307. Navigation DMA 205 finishes by transmitting package 4 and generates signal S206. CPU 107 receives signal S206 and executes Read step. Then all the steps are repeated cyclically.

Navigation system 200 processes GNSS signals in a pipeline mode with CLKnav and generates packages using modules NS2CS 202 providing a greater flexibility in GNSS signals processing. The formation of packages is tied to tick signal S106. The packages are further processed in CPU System 210 based on clock CLKcpu.

Samples from all re-quantizer 103 are combined in one interface block NS2CS 202, then a package is formed, and this package is written to memory 109. The package, via Navigation DMA 205, is input to Navigation channels 104 where it is processed based on clock CLKcpu. Interface block NS2CS 202 generates packages one after another providing pipeline processing of GNSS signals in navigation channels 104. In one embodiment, interface block NS2CS 202 generates packages one after another without any loss of data. CPU 107 controlling and reading of the data from navigation channels 104 is implemented between package processing.

Packages in navigation channels 104 can be processed in the following modes: CPU fully controlled mode and first-try automatic mode.

In one embodiment, in CPU fully controlled mode: CPU 107 controls all the processes and the package is equal to the period of Tick S106.

In one embodiment, in first-try automatic mode: CPU 107 controls and reads data from navigation channels 104 between packages per period of tick signal S106. In this mode, the size of the package is reduced in several times, and memory 109 is used less size. Navigation DMA 205 transmits first package that is formed from packages per period of tick signal S106 to navigation channels 104 by command CPU 107. Next, packages are formed from packages per period of tick signal S106, interface block NS2CS 202 automatically informs navigation DMA 205 about readiness of a new package, and it allows transmission of part of the packages to navigation channels 104 automatically. Navigation DMA 205 reads a package from memory 109 and transmits it to navigation channels 104.

In one embodiment, in operation of the interference suppressor (e.g., signal processor 102) it is necessary to detect interference in navigation system 200. To do this, a spectrum analyzer (e.g., hardware accelerator 204) located in the CPU System is used. A package formed by interface block NS2CS 202 is processed in the spectrum analyzer. CPU 107 analyzes the result and controls the interference suppressor.

In another embodiment, after an ASIC has been produced, an additional filter may be needed in the Navigation System. Hardware accelerator 204 can be used as such a filter (e.g., embedded in ASIC: FPGA or CGRA are used). In this case, there is a chain providing Pipeline processing of a GNSS signal in navigation channels 104. Samples from the output of signal processor 102 are input to interface block NS2CS 202 that forms a package. The package of interface block NS2CS 202 is synchronized with tick signal S106 and processed in hardware accelerator 204. Hardware accelerator 204 forms a package and writes it in memory 109. Interface block CS2NS 203 retrieves the packages from memory 109 and sends data back to the chain of signal processing in navigation system 200. Data from interface block CS2NS 203 is synchronized with tick signal S106 which allows consideration of a signal delay during signal processing in navigation channels 104.

In one embodiment, the package can be processed by the CPU 107 to provide flexibility. Packages are recorded and stored in memory 109 for further processing.

Interface block NS2CS 202 has a built-in decimator NS2CS 301, which, if necessary, reduces the number of samples in the package. This makes it possible to reduce the processing time of data in CPU 107 or in the hardware accelerator 204.

In one embodiment, when navigation channels 104 works with data (e.g., samples from 103 and Tick S106) from AFIFO 214, Navigation DMA 205 is not used, then, we get a mode similar to the operation of a standard GNSS receiver and all the possibilities of additional processing of GNSS signals remain.

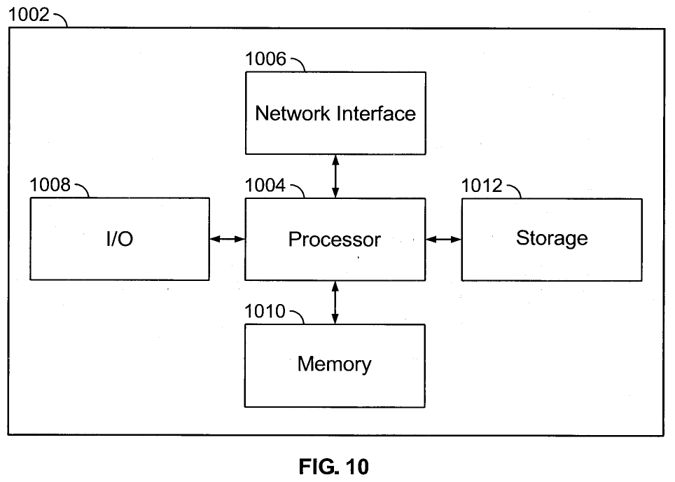

In one embodiment, a computer is used to perform the operations of the components and equations described herein and shown, for example, in FIGS. 2A, 2B, 3, 5, 6A, 6B, and 8. The components may be, for example, ADCs, signal processors, re-quantizers, etc. A high-level block diagram of such a computer is illustrated in FIG. 10. Computer 1002 contains a processor 1004 which controls the overall operation of the computer 1002 by executing computer program instructions which define such operation. The computer program instructions may be stored in a storage device 1012, or other computer readable medium (e.g., magnetic disk, CD ROM, etc.), and loaded into memory 1010 when execution of the computer program instructions is desired. Thus, the components and equations described herein can be defined by the computer program instructions stored in the memory 1010 and/or storage 1012 and controlled by the processor 1004 executing the computer program instructions. For example, the computer program instructions can be implemented as computer executable code programmed by one skilled in the art to perform an algorithm defined by the components and equations described herein. Accordingly, by executing the computer program instructions, the processor 1004 executes an algorithm defined by the components and equations described herein such as the components shown in FIGS. 2A, 2B, 3, 5, 6A, 6B, and 8. The computer 1002 also includes one or more network interfaces 1006 for communicating with other devices via a network. The computer 1002 also includes input/output devices 1008 that enable user interaction with the computer 1002 (e.g., display, keyboard, mouse, speakers, buttons, etc.) One skilled in the art will recognize that an implementation of an actual computer could contain other components as well, and that FIG. 10 is a high-level representation of some of the components of such a computer for illustrative purposes.

The foregoing detailed description is to be understood as being in every respect illustrative and exemplary, but not restrictive, and the scope of the inventive concept disclosed herein should be interpreted according to the full breadth permitted by the patent laws. It is to be understood that the embodiments shown and described herein are only illustrative of the principles of the inventive concept and that various modifications may be implemented by those skilled in the art without departing from the scope and spirit of the inventive concept. Those skilled in the art could implement various other feature combinations without departing from the scope and spirit of the inventive concept.

1. A navigation receiver comprising:
a plurality of RF paths configured to receive GNSS signals from an antenna and transmit the GNSS signals in a frequency range for digitizing the GNSS signals;
a navigation system configured to process the GNSS signals based on clock CLKnav, the navigation system comprising:
a plurality of analog to digital convertors (ADC) configured to digitize signals from the plurality of RF paths;
a plurality of signal processors configured to process the digitized signals;
a plurality of re-quantizers configured to convert the digitized signals into low-bit data;
a plurality of interface blocks NS2CS configured to generate packages;
a plurality of interface blocks C2N configured to convert the packages into data;
a MUX interconnect configured to distribute the data, from outputs of the plurality of ADCs, the signal processors and the re-quantizers to inputs of interface blocks NS2CS, and from outputs of interface blocks CS2NS to the plurality of signal processors and the plurality of re-quantizers;
a time control configured to adjust a time scale to generate a tick signal;
an asynchronous first-in first-out (AFIFO) configured to send the low-bit data and the tick signal to the plurality of channels for processing; and
a CPU System configured to process the packages based on clock CLKcpu, the CPU system comprising:
a memory configured to store the data and the packages;
a plurality of hardware accelerators configured to process the packages;
a navigation DMA configured to convert the packages into data for a plurality of channels;
a commutator configured to select data from the navigation DMA; and
a CPU configured to synchronize control between the plurality of signal processors, the plurality of re-quantizers, interface blocks NS2CS, interface blocks CS2NS, the plurality of hardware accelerators, and the navigation DMA based on the tick signal, and configured to control the navigation system and the CPU system, read and process a result of GNSS signal processing from the plurality of channels that are configured to process data from the navigation DMA or AFIFO,
wherein an operation frequency of the navigation DMA and the plurality of channels is synchronous and equal to or greater than the clock CLKcpu.

2. The navigation receiver of claim 1, wherein the interface blocks NS2CS convert the digitized signal into a package of pre-set size and re-synchronize data from clock CLKnav to clock CLKcpu.

3. The navigation receiver of claim 1, wherein the interface blocks NS2CS write the packages into memory and generate a RUN signal that is transmitted to the Navigation DMA and an interrupt request signal that is transmitted to the CPU.

4. The navigation receiver of claim 1, wherein the interface blocks NS2CS receive low-bit data from a number of the plurality of re-quantizers and convert the low-bit data into one package of a designated size transmission to memory for the Navigation DMA.

5. The navigation receiver of claim 1, wherein the interface blocks NS2CS are configured to decimate the digitized signal and re-quantize the decimated signal into low-bit data.

6. The navigation receiver of claim 1, wherein the interface blocks NS2CS are configured to form the packages according to the tick signal and generate packages one after another without any loss of data.

7. The navigation receiver of claim 1, wherein the interface blocks NS2CS are configured to generate one or more packages over period of the tick signal.

8. The navigation receiver of claim 3, wherein the Navigation DMA reads a package from the memory based on one of the RUN signals or a command received from the CPU.

9. The navigation receiver of claim 1, wherein the Navigation DMA fixes the data readiness in a plurality of channels according to signals of an integration period, and the CPU reads signals from the plurality of channels after data processing.

10. The navigation receiver of claim 8, wherein after processing of the last packages during a current period of the tick signal, the Navigation DMA generates an interrupt request that is transmitted to the CPU.

11. The navigation receiver of claim 8, wherein the CPU reads ready data from the plurality of channels and sends a current channel configuration and control to the plurality of channels between processing packages.

12. The navigation receiver of claim 1, wherein in response to a command from the CPU, one of the plurality of hardware accelerators reads the package from memory or receives the package from interface blocks NS2CS, processes the package, and then generates an interrupt request that is transmitted to the CPU.

13. The navigation receiver of claim 12, wherein the one of the plurality of hardware accelerators receives and processes a package and converts the processing result into a package that is written into the memory or to a different one of the plurality of hardware accelerators, and then generates an interrupt request that is transmitted to the CPU.

14. The navigation receiver of claim 1, wherein the interface blocks CS2NS read a package from the memory and transmit data via the MUX interconnect to one of the plurality of signal processors or one of the plurality of re-quantizers, and re-synchronizes data from clock CLKcpu to clock CLKnav.

15. The navigation receiver of claim 14, wherein the interface blocks CS2NS, based on a tick signal, starts to send the data, and when receiving data ends, generates an interrupt request transmitted to the CPU.

16. The navigation receiver of claim 1, wherein the CPU reads and processes a package from memory and converts a processing result into a package and writes the package to the memory.

17. The navigation receiver of claim 3, wherein the CPU processes an interrupt request from one of the interface blocks NS2CS, the interface blocks CS2NS, the hardware accelerators and the navigation DMA.

18. The navigation receiver of claim 1, wherein the channels use the tick signal from an output of the AFIFO to process low-bit data from the AFIFO.

19. The navigation receiver of claim 1, wherein signal processing chains can be assembled from any combination of components comprising a CPU, a signal processor, interface blocks NS2CS, interface blocks CS2NS, re-quantizers, hardware accelerators, AFIFO, navigation DMA, and navigation Channels.
